(19) United States
(12) Patent Application Publication
(10) Pub. No.: US 2018/0314710 A1
(43) Pub. Date: Nov. 1, 2018

(54) FLATTENED DOCUMENT DATABASE WITH COMPRESSION AND CONCURRENCY

(71) Applicant: Aria Solutions, Inc., Calgary (CA)

(72) Inventor: Paul Peloski, Calgary (CA)

(21) Appl. No.: 15/686,911

(22) Filed: Aug. 25, 2017

Related U.S. Application Data
(60) Provisional application No. 62/492,269, filed on Apr. 30, 2017.

(51) Int. Cl. G06F 17/30

(52) U.S. Cl. CPC G06F 17/30097; G06F 17/30115; G06F 17/30138; G06F 17/30168

(57) ABSTRACT

A system for a flattened document database with compression and concurrency, comprising a fragmentation module that divides a structured data file into fragments, computes hash values for the fragments, and produces an index file from the resulting hash values. The fragments are produced according to a key-value pair structure, wherein each key corresponds to a unique fragment of data in the structured data file, each value corresponds to the data within the fragment; and the index file identifies each fragment by a corresponding hash value, and each hash value corresponds to a fragment of the structured data file.

### CROSS-REFERENCE TO RELATED APPLICATIONS

This application claims priority to U.S. provisional patent application 62/492,269, titled “MULTIPLE INTERACTIVE LIVE MONITORING”, which was filed on Apr. 30, 2017, the entire specifications of each of which are incorporated herein by reference.

### BACKGROUND OF THE INVENTION

### Field of the Art

The disclosure relates to the field of electronic storage, and more particularly to the field of database structures and conversion techniques.

### Discussion of the State of the Art

In data storage, document databases are often used for storing, retrieving, and managing document-oriented information, also known as semi-structured data. A general approach is to use a form of key-value store, wherein data is considered opaque to the database and a system relies on internal structure within a document itself to extract metadata for further optimization. This is in contrast to a relational database, wherein data is stored in defined tables, and a single object may be spread across multiple tables. A document database stores all information for a given object in a single instance in the database, and every object stored may be different.

A document-oriented database generally offers better performance and scales more easily than a relational database, but does not provide the implicit data concurrency of a relational database. Additionally, data security can be a concern as adding encryption or compression techniques rapidly offsets performance gains.

What is needed, is a new approach for a document-oriented database, that offers improved performance without losing compression features, and that offers data concurrency as an implicit feature of the storage scheme.

### SUMMARY OF THE INVENTION

Accordingly, the inventor has conceived and reduced to practice, in a preferred embodiment of the invention, a flattened document database with compression and concurrency.

The flattened document database described herein provides a novel approach that offers improved performance without losing compression features, and that offers data concurrency as an implicit feature of the storage scheme. Documents may be stored and interacted with according to data fragments, enabling efficient interaction with discrete portions of data without loading or affecting the rest of the document. Concurrency is ensured by only modifying the specific fragment or fragments needed, and data storage is economized by flattening a document into a key-value structure and optionally compressing the resulting table of values to further optimize performance.

According to a preferred embodiment of the invention, system for a flattened document database with compression and concurrency, comprising: a data normalization module comprising at least a plurality of programming instructions stored in a memory and operating on a processor of a network-connected computing device and configured to divide at least an unstructured data file into a plurality of fragments, wherein the fragments are produced according to a key-value pair structure, wherein each key corresponds to a unique fragment of data in the unstructured data file and wherein each value corresponds to at least a portion of the data within the unique fragment; a data hashing module comprising at least a plurality of programming instructions stored in a memory and operating on a processor of a network-connected computing device and configured to compute a plurality of hash values for each of at least a portion of the plurality of fragments wherein each hash value uniquely corresponds to a particular fragment of the unstructured data file; and a data indexing module and configured to produce an index file from at least a portion of the resulting hash values, wherein the index file uniquely identifies each fragment by each corresponding hash value, is disclosed.

According to another preferred embodiment of the invention, a method for a flattened document database with compression and concurrency, comprising the steps of: retrieving at least an unstructured data file; dividing, using a data normalization module comprising at least a plurality of programming instructions stored in a memory and operating on a processor of a network-connected computing device, and configured to divide at least an unstructured data file into a plurality of structured key-value based fragments wherein the key is derived from a keyword within each fragment; computing a plurality of unique hash values for each of at least a portion of the plurality of fragments using a data hashing module comprising at least a plurality of programming instructions stored in a memory and operating on a processor of a network-connected computing device; and producing an index file from at least a portion of the resulting hash values, to allow the directed retrieval of each key-value based fragment using a data indexing module comprising at least a plurality of programming instructions stored in a memory and operating on a processor of a network-connected computing device, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary system architecture for a flattened document for database storage with compression and concurrency, according to a preferred embodiment of the invention.

FIG. 2 is a flow diagram illustrating an exemplary method for converting and storing documents in a flattened document database with compression and concurrency, according to a preferred embodiment of the invention.

FIG. 3 is a flow diagram illustrating an exemplary method for retrieving and presenting a flattened document from storage within the system, according to a preferred embodiment of the invention.

FIG. 4 is a block diagram illustrating an exemplary hardware architecture of a computing device used in an embodiment of the invention.

FIG. 5 is a block diagram illustrating an exemplary logical architecture for a client device, according to an embodiment of the invention.

FIG. 6 is a block diagram showing an exemplary architectural arrangement of clients, servers, and external services, according to an embodiment of the invention.

FIG. 7 is another block diagram illustrating an exemplary hardware architecture of a computing device used in various embodiments of the invention.

### DETAILED DESCRIPTION

The inventor has conceived, and reduced to practice, in a preferred embodiment of the invention, a flattened document database with compression and concurrency.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

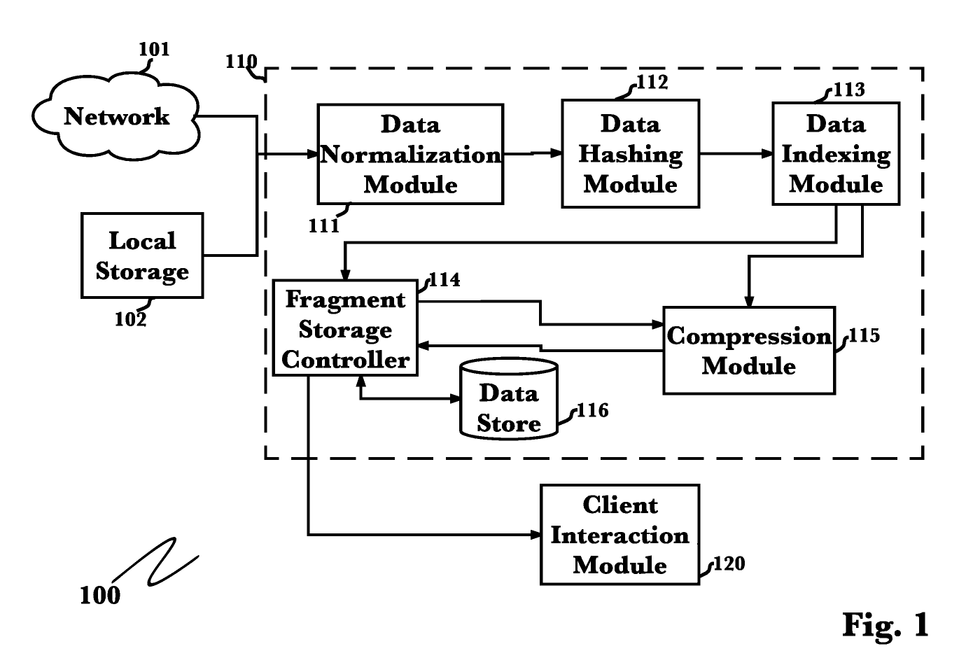

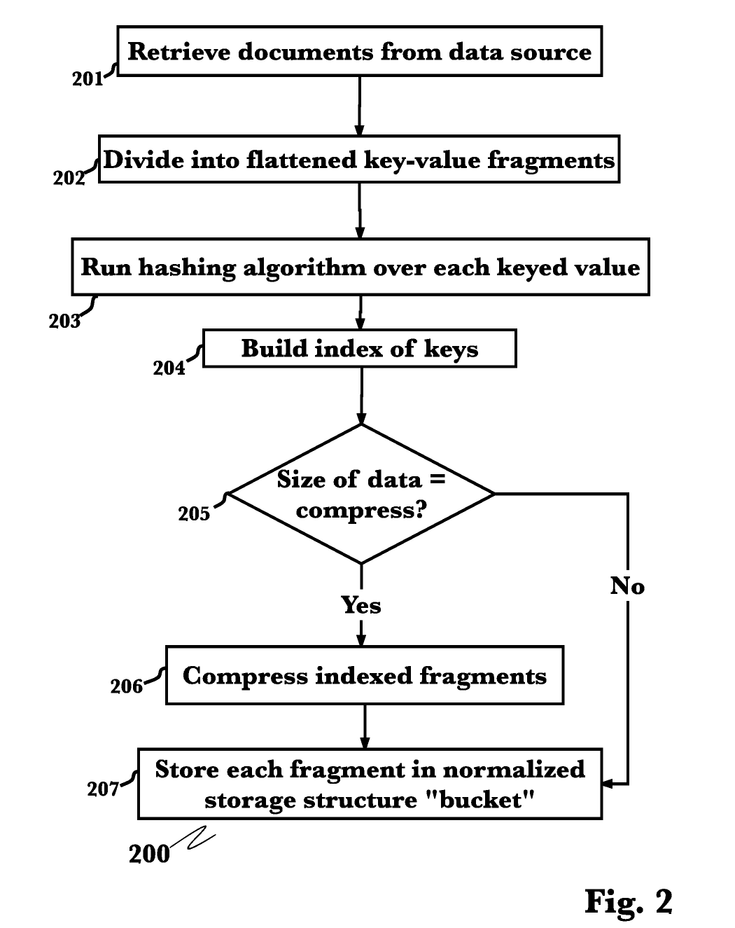

FIG. 1 is a block diagram illustrating an exemplary system architecture for a flattened document for database storage 100 with compression and concurrency, according to a preferred embodiment of the invention. According to the embodiment 110, a data normalization module 111 may receive a document (which may comprise any of a variety of structured data, as described below) from an input source such as (for example, including but not limited to) another database accessible via a network 101, direct user input such as loading a file from local device storage 102, or other data sources. The data normalization module may first analyze the incoming data for integrity and content length as well as structure and then process the unstructured document data for storage and subsequent rapid retrieval by dividing the document into a predetermined number of fragments each comprising a key-value pair describing the data contained within that particular portion of the document. This process may be referred to as “flattening” the document, wherein a complex data file is reduced to a consistent table of entries that describe its contents in an efficient, structured manner. The data hashing module 112 may then further process this document derived key-value table using any of a number of hashing algorithms to produce unique hash data for each key in the table. The data indexing module 113 may then use the hashed key-value pairs to build an index file, as described below (referring to FIG. 2). Entries in a document's index file thus uniquely describe each key in the flattened document's key-value table and may be used to look up specific keys (and thus document fragments, the values to which the keys point) allowing for piecewise manipulation of a document's contents. This may be used to facilitate much more efficient data interaction than is generally possible according to traditional implementations.

Document fragments may then be directly packaged in a fragment storage controller 114 for storage in a data store 116 for future retrieval and use, or they may first be processed by a compression module 115 to compress individual fragments for more efficient storage (as described below, again referring to FIG. 2). When fragments are requested, they may be directly provided from storage 114 to a requesting client 120 application (for example, another database requesting a copy of the data, or a user interface wherein a user is requesting to view or modify data), or if necessary they may first be provided to compression module 115 by the fragment storage controller 114 to be decompressed and restored to their original state, and then provided to client 120.

A central concept of a document-oriented database is the notion of a document. Generally, a document encapsulates and encodes information in some standard format or encoding. Exemplary encodings that may be used may include (but are not limited to) XML, YAML, JSON, or BSON, as well as binary formats such PDF, DOCX, or other types.

### Detailed Description of Exemplary Embodiments

FIG. 2 is a flow diagram illustrating an exemplary method for converting and storing documents in a flattened document database with compression and concurrency, 200 according to a preferred embodiment of the invention. In an initial step 201, a data normalization module 111 may retrieve document data comprising a document or document portion (for example for modifications or additions to a previously-stored document) for processing. In a next step 202, the data may be converted the document data into a flattened “list of things,” using a key-value pair structure. In a next step 203 each key may then be run through a hashing algorithm by a data hashing module 112 to produce a plurality of unique hashed values corresponding to the keys, and these hash values may then 204 be used by a data indexing module 113 to build an index file corresponding the keys to their values and describing each key-value pair as a “fragment” of the document as a whole. Depending on the size of the data 205, they may be compressed 206 by a compression module 115 to save space in storage 116. Storage may be abstractly represented as occurring in a number of “buckets” 207 of standardized size which may correspond to a database record or a flat file depending on the underlying storage method. This method may increase the size of the storage pool for a plurality of the stored documents, but such an increase in storage requirements is more than offset by reduction of processing power needed, increase in transaction speed and increased flexibility of data manipulation. For ease of document manipulation and retrieval, data may be stored through appending the new data in “buckets” at the end of older document data thus allowing immediate retrieval of some parts of a document while subsequent portions are still being stored. In this manner, it may be appreciated that discrete portions of document data may be manipulated without affecting the rest of the document, enabling more efficient data operations and ensuring data concurrency by locking only the specific data being modified, rather than an entire document. Additionally, storing a document using an append-only state, such that changes are made by appending a new fragment that supersedes an existing, previously-stored one. This approach enables version control and history, as well as further enhancing data concurrency.

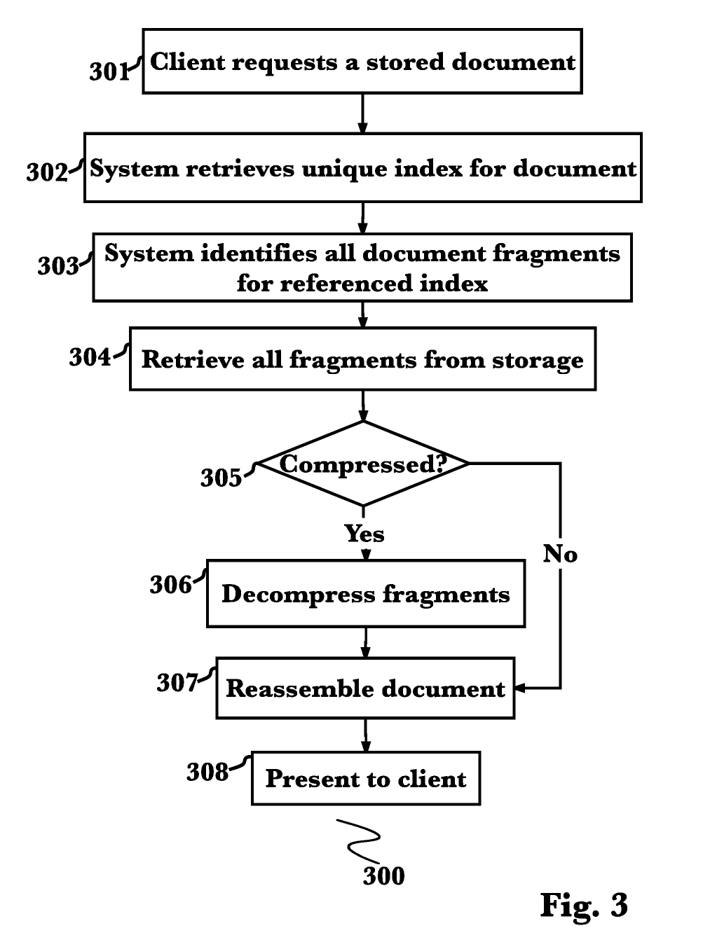

FIG. 3 is a flow diagram illustrating an exemplary method for retrieving and presenting a flattened document from storage within the system 300, according to a preferred embodiment of the invention. Documents stored by the system may be retrieved by other database services, document dependent services, or directly by users in need of a particular document of documents 301. Such requests are interpreted by the fragment storage controller 114 to map the document that is being requested to the key-hash based index data for the document being stored 302. The index may then be used to identify all fragments, which may include fragments from multiple versions and edits of that document as described above (see FIG. 2) 303. Flattened document fragment data are then retrieved from all associated storage buckets 304. Fragment data may have been compressed based upon storage space saved versus increased processing overhead for each document 305. If the data has been compressed, the fragment storage controller 114 may first send it to the compression module 115 to be re-expanded 306 before it is reassembled 307 and sent for its intended use to the client 120 that requested it 308

An exemplary document that may be processed and stored by the system as shown below.

```
{
    a : 1
    b : 2
    c : [ 1, 2, 3 ]
    d: {
        e : 1
        f : [ 1, 2 ]
    }
}
```

Once flattened into fragments comprising key-value pairs, this same document might then have the structure below.

| Key | Value |
|---|---|
| a | 1 |
| b | 2 |
| c | [ 1, 2, 3 ] |
| d/e | 1 |
| d/f | [ 1, 2 ] |

Using the index file, a number of functions may be provided such as (for example, including but not limited to) storing an object (such as a document or data within a document), retrieving an object such as a document's index, retrieving all fragments in an index to grab all fragments and reconstitute the entire document into its original form, or to retrieve specific fragments for an optimal partial read operation.

Storage structures, which may be, for example, files or database records, among other possibilities known to those skilled in the art, for document portions may also be described as “buckets” of data, with each bucket containing a number of key-value pairs. Each document's index file may comprise a starting point for each bucket, enabling efficient interaction with discrete portions of data. If a particular document only comprises a single bucket, retrieval operations will always return the complete document data; however, if a document comprises multiple buckets (any arbitrary number), individual buckets may be retrieved to allow for piecewise manipulation of document data in an efficient manner. As an index grows to accommodate more data, file handles also grow accordingly but the size ultimately is dependent on the corpus involved. An exemplary bucket arrangement for an exemplary document is shown below.

Buckets (for Example, Files on Disks)

| | |
|---|---|
| 1 | {a:1, b:2} |
| 2 | (d\|f:[1, 2]} |
| 3 | {c:[1, 2, 3]} |
| 4 | { } |
| ... | |
| 64 | {d\|e:1} |

This approach to document storage offers efficient interaction with discrete portions of document data, and distributes keys efficiently. There may be a tradeoff in terms of storage space utilized (depending on the data being stored), but the overall computing overhead is much reduced for overall enhanced system operation. Buckets may utilize compression, for example deflate compression or Huffman coding. This differs from traditional approaches that utilize compression for an entire document, and not for discrete portions of documents. In this manner, manipulation of smaller portions of data is still possible while maintaining compression and reducing resource overhead. When a bucket is being decompressed, a table of elements that decode may be written to the disk as part of the process. An exemplary compression approach may utilize zlib, so that data may be passed through the compression algorithm as it is processed. Because zlib relies on pattern-matching in its compression approach, a table of patterns may be built as part of the process, and patterns are identified as data is passed to zlib for compression.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

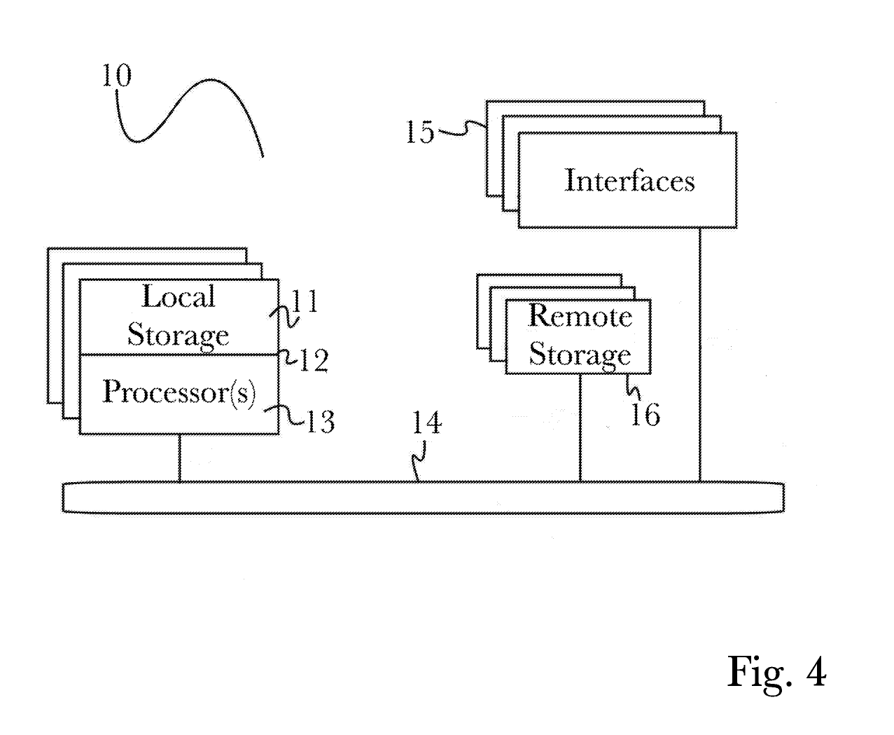

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 4 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

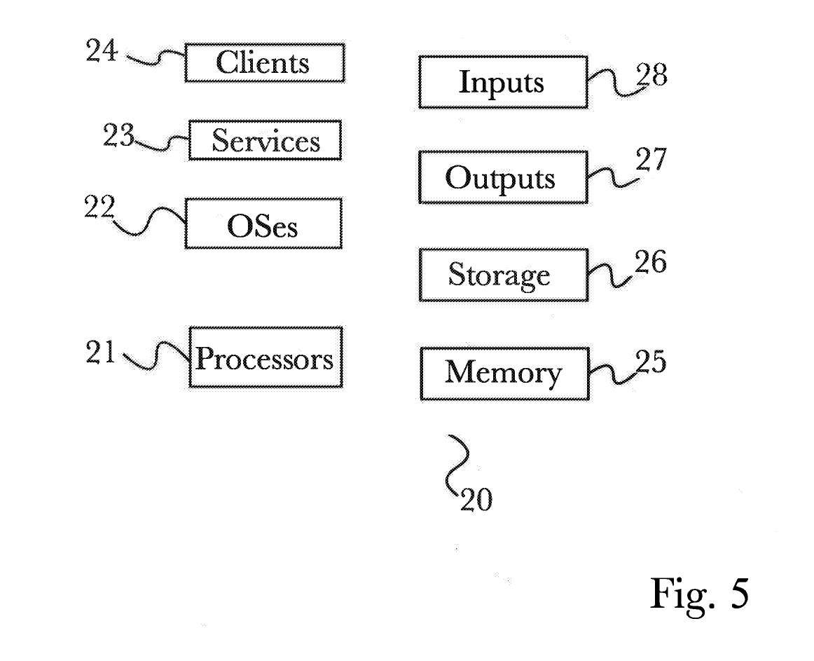

In some embodiments, systems according to the present invention may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

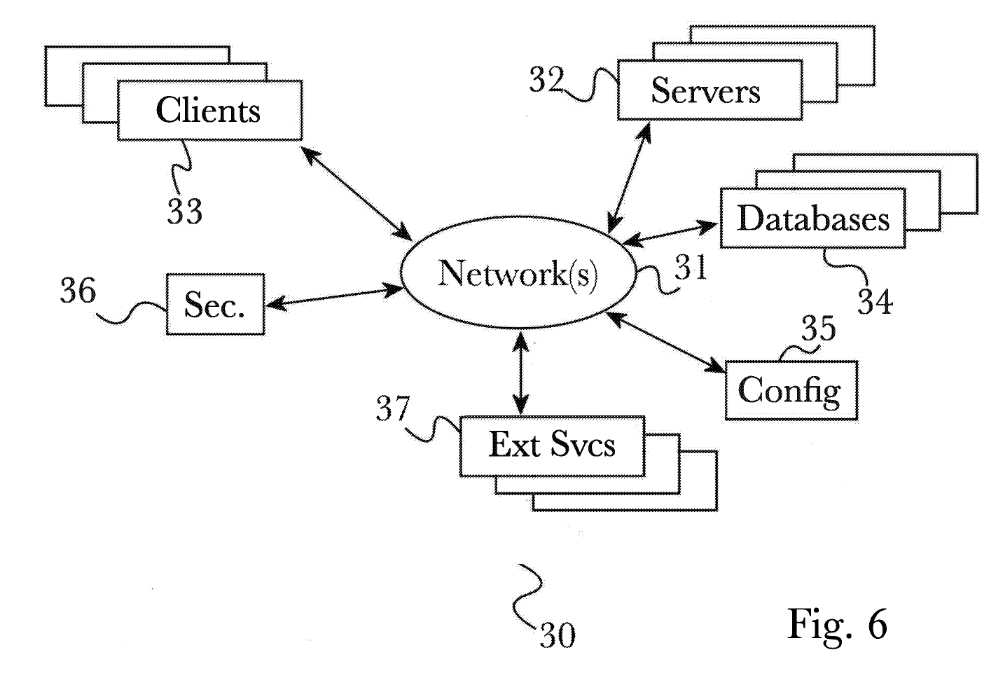

In some embodiments, systems of the present invention may be implemented on a distributed computing network, such as one having any number of clients and/or servers. Referring now to FIG. 6, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 4. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

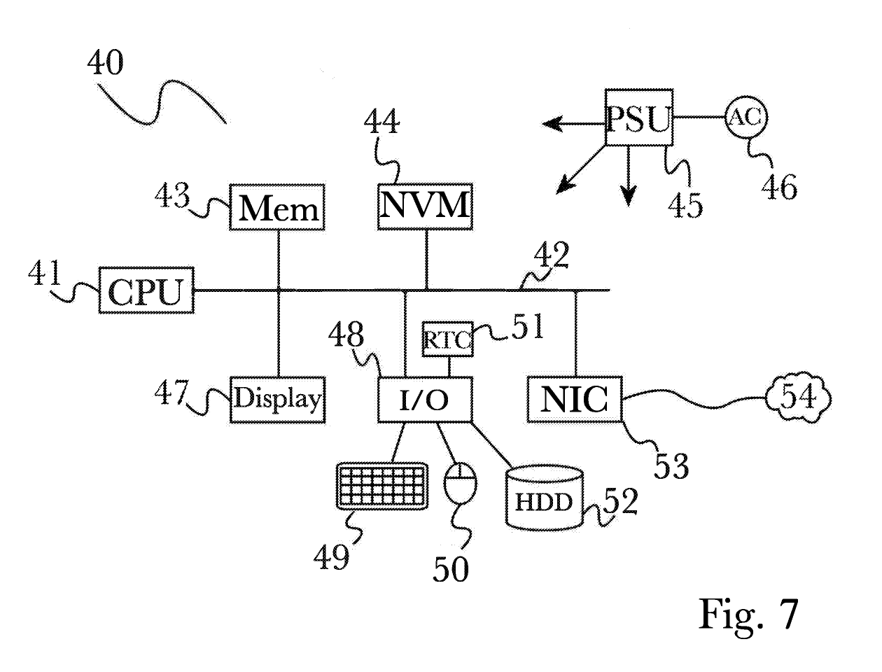

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for a flattened document database with compression and concurrency, comprising:
a data normalization module comprising at least a plurality of programming instructions stored in a memory and operating on a processor of a network-connected computing device and configured to divide at least an unstructured data file into a plurality of fragments, wherein the fragments are produced according to a key-value pair structure, wherein each key corresponds to a unique fragment of data in the unstructured data file and wherein each value corresponds to at least a portion of the data within the unique fragment;
a data hashing module comprising at least a plurality of programming instructions stored in a memory and operating on a processor of a network-connected computing device and configured to compute a plurality of hash values for each of at least a portion of the plurality of fragments wherein each hash value uniquely corresponds to a particular fragment of the unstructured data file; and
a data indexing module comprising at least a plurality of programming instructions stored in a memory and operating on a processor of a network-connected computing device, and configured to produce an index file from at least a portion of the resulting hash values, wherein the index file uniquely identifies each fragment by each corresponding hash value.

2. A method for a flattened document database with compression and concurrency, comprising the steps of:
receiving at least an unstructured data file;
dividing, using a data normalization module comprising at least a plurality of programming instructions stored in a memory and operating on a processor of a network-connected computing device, and configured to divide at least an unstructured data file into a plurality of structured key-value based fragments wherein the key is derived from a programmatically selected unique keyword within each fragment;
computing a unique hash value for each of at least a portion of the plurality of fragments using a data hashing module comprising at least a plurality of programming instructions stored in a memory and operating on a processor of a network-connected computing device; and
producing an index file from at least a portion of the resulting unique hash values, using a data indexing module comprising at least a plurality of programming instructions stored in a memory and operating on a processor of a network-connected computing device to allow the directed retrieval of each key-value based fragment.
